(19) United States
(12) Patent Application Publication
(10) Pub. No.: US 2025/0285818 A1
(43) Pub. Date: Sep. 11, 2025

(54) RACK AUTOMATIC TRANSFER SWITCH WITH ELECTRONIC BYPASS

(71) Applicant: Legrand DPC, LLC, West Hartford, CT (US)

(72) Inventors: Thomas Hsueh, Taipei City (TW); Alex Lee, New Taipei City (TW); Stefan Oebser, Zwickau (DE); Michael Suchoff, Palm Beach, FL (US); Christian Krause, Zwickau (DE); Ingo van Lil, Zwickau (DE); Swen Anderson, Limbach-Oberfrohna (DE); Erich Beyer, Reno, NV (US); Dean Macy, Sparks, NV (US); William Harold Avery, JR., Reno, NV (US)

(21) Appl. No.: 18/601,574

(22) Filed: Mar. 11, 2024

(51) Int. Cl. H01H 9/00; H02J 9/06

(52) U.S. Cl. CPC H01H 9/0027; H02J 9/06; H01H 2300/018

(57) ABSTRACT

The technology relates to a method of provisioning power and a switching device or a system implementing such method. The method may include providing a switching device including an automatic transfer switch module, an electronic bypass module in electrical communication with said automatic transfer switch module, a plurality of inlets, and a plurality of outlets. The inlets are connected to different power sources to provide uninterrupted power to the plurality of outlets. The method may also include continuing to provide uninterrupted power upon disconnection of either the automatic transfer switch module or the electronic bypass module from the switching device.

### BACKGROUND

An automatic transfer switch, “ATS”, is an electrical device that supplies electrical power to one or more electrical loads by connecting the electric loads to one of two power sources. The primary purpose of an ATS is to ensure delivery of power to the electrical loads if one of the power sources is unable to supply power. If a problem is detected with the power source connected to the electric loads, an ATS, without requiring operator intervention, can disconnect the problematic power source and connect the electrical loads to the other power source. Use of two power sources and an ATS reduces the mean time between failure, “MTBF”, of power delivered to the electrical loads due to power source failure.

An ATS can include sensor circuits, power switching circuits, control circuits, operator interface circuits, and optionally, communication circuits. The sensor circuits measure voltages of the two power sources and are monitored by the control circuitry which monitors power quality parameters, such as voltage levels and frequency, of each power source. If the power quality parameters are outside an acceptable range, as configured by the operator using an operator interface and/or optional communication circuits, the control circuitry signals the power switching circuitry to disconnect the electrical loads from the problematic power source and connect the electrical loads to the other power source. This helps to minimize the cumulative time taken by the circuitry to (1) detect power quality is outside acceptable range, (2) disconnect the electrical loads from the problematic power source, and (3) connect the electrical loads to the other power source in order to avoid malfunction of the electrical loads due to power source failure.

An ATS can use relays or contactors for the power switching circuitry. Some ATS, commonly called static transfer switches, use semiconductor devices for the power switching circuitry. Some ATS, commonly called hybrid transfer switches, use relays or contactors and semiconductor devices in parallel as the power switching circuitry. Use of the term “automatic transfer switch” or “ATS” in this patent application refers to any automatic transfer switch irrespective of the type of power switching circuitry utilized.

A rack ATS is an ATS built into an enclosure that can be mounted within a computer server rack cabinet. A rack ATS contains two inlets to which the power sources are connected and contains one or more outlets to which electrical loads within the rack, such as computers, memory storage units, and networking equipment, are connected.

If a failure or malfunction occurs within the circuitry of a rack ATS, the repair process can require a time-consuming, complex procedure to replace the rack ATS with a properly functioning ATS. The replacement procedure typically requires: (1) turning off the two power sources, (2) disconnecting the power source cables and electrical load power cables from the rack ATS's inlets and outlet(s), (3) removing the rack enclosure containing the faulty ATS from the rack, (4) installing a replacement rack ATS back into the rack, (5) reconnecting the power cables to the rack ATS's inlets and outlets, and (6) turning on the two power sources. The average time required to replace a malfunctioning device is known as the “Mean Time To Repair”, “MTTR”. It is highly desirable to reduce the MTTR as it reduces the time the electric load(s) are without power.

An electromechanical bypass is sometimes included with a rack ATS to reduce the complex procedure and the MTTR required to replace a malfunctioning automatic transfer switch. A rack ATS with electromechanical bypass typically comprises (1) a rack mountable enclosure containing two inlets, one or more outlets, and an electromechanical bypass including a selector switch and, optionally, circuitry such as relays and contactors, and (2) a field replaceable ATS module. The replacement procedure typically requires: (1) rotating the selector switch through a sequence of steps which electrically disconnects the ATS module and electrically connects the outlets through the bypass to one of the inlets, (2) removing the malfunctioning ATS module from the enclosure and inserting a replacement, and (3) rotating the selector switch back to its original position to enable the replaced ATS module to control which inlet powers the outlet(s).

FIG. 1 illustrates an example of a selector switch 100 incorporated into a mechanical bypass according to existing implementations. A seven position, or seven pole, selector switch is used to perform the bypass. Bypassing is done in a sequence of steps that ensures power to the outlets is not interrupted and ensures a short circuit between the two inlets does not occur. A short circuit could damage both the ATS module and the electromechanical bypass. The bypass sequence begins with selector switch in the AUTOMATIC position 104, allowing the ATS module to determine which inlet powers the outlets. Rotating to position 103, the ATS module connects the outlets to inlet 1 and is prevented from switching the outlets to inlet 2. Rotating to position 102, the outlets are connected to inlet 1 through both the ATS module and the electromechanical bypass. Finally, rotating to position 101, the outlets are connected to inlet 1 only through the electromechanical bypass and the ATS module is turned off and can be safely removed and replaced.

An electromechanical bypass built into a rack enclosure has size, failure, and operator error problems. For example, selector switches, with the required number of poles and throws and that are safety rated to carry the power source voltages, can be large in size which can cause the height of the rack enclosure to be two or more rack spaces tall. Minimizing the height of the rack enclosure is desirable to allocate more rack space for electrical loads within the rack.

A failure of the selector switch or the circuitry associated with the bypass requires removal and replacement of the rack enclosure using the same time-consuming and complex procedure required to replace a malfunctioning rack ATS that does not contain a bypass. During the replacement procedure, power is not available to the electrical loads.

Attention must be taken operating selector switch. If an operator makes an error by rotating the selector switch to an inlet with a failed power source, the electrical loads lose power.

### BRIEF DESCRIPTION OF THE DRAWINGS

Detailed descriptions of implementations of the present invention will be described and explained through the use of the accompanying drawings.

FIG. 1 illustrates an example selector switch that can be incorporated into a mechanical bypass.

FIG. 2A illustrates front and rear perspective views of an embodiment of a rack ATS with electronic bypass 270.

FIG. 2B illustrates a representative front panel 200 of an automatic transfer switch module 283 of the rack ATS with electronic bypass 270.

FIG. 2C illustrates a representative layout of a front panel 250 of an electronic bypass module 282 of the rack ATS with electronic bypass 270.

FIG. 3 is a block diagram illustrating interconnection wiring of an automatic transfer switch module 283 and electronic bypass module 282 contained in the rack ATS with electronic bypass 270.

FIG. 4 is a flowchart illustrating a representative algorithm which may be used by an electronic bypass module's microprocessor 313 to bypass the ATS module so that it can be replaced, according to some implementations.

FIG. 5 is a flowchart illustrating a representative algorithm which may be used by the electronic bypass module's microprocessor 313 to disconnect the electronic bypass module from an inlet.

FIG. 6 is a flowchart illustrating a representative process for provisioning power from one of the inlets to the outlets, according to some implementations.

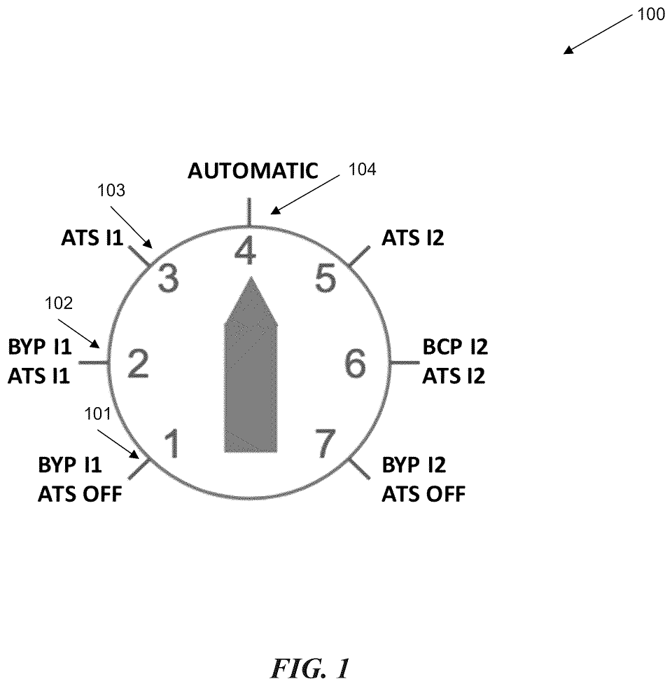

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technologies broadly describe a switching device. More particularly, the disclosed technologies describe rack-mountable switching device in the form of an automatic transfer switch with electronic bypass including (1) a field replaceable plug-in module containing an automatic transfer switch (ATS module), (2) a field replaceable plug-in module containing an electronic bypass (electronic bypass module), and (3) a rack mountable enclosure including two inlets, one or more outlets, and a backplane into which the ATS module and the electronic bypass module are inserted. The backplane allows connection of the two modules to the inlets and outlets and to each other.

The disclosed electronic bypass module overcomes size disadvantages of an electromechanical bypass. An enclosure containing an electromechanical bypass is two or more rack spaces tall, i.e., 3.5 inches, whereas a rack ATS with electronic bypass is one rack space in height, i.e., 1.75 inches. The size reduction is primarily due to elimination of a large multi-pole, multi-throw high-voltage selector switch, replacing it with a small 3-pole single-throw low-voltage selector switch and a microprocessor. The electronic bypass module's microprocessor communicates with the ATS module's microprocessor to perform the sequence of steps necessary to accomplish a bypass without causing a short circuit or loss of power to the electrical loads.

The disclosed electronic bypass module overcomes the failure disadvantages of an electromechanical bypass. Replacement of an electromechanical bypass can require a complex and time-consuming procedure to replace the entire rack automatic transfer switch during which time power is not available for the electrical loads. The replacement procedure for a malfunctioning electronic bypass module includes unplugging the malfunctioning electronic bypass module from the enclosure and then plugging in a replacement module. Power to the electrical loads is maintained during the replacement procedure.

The disclosed electronic bypass can prevent operator error. The electronic bypass module's microprocessor controls the bypass process and can prevent bypass to an inlet with a failed power source.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

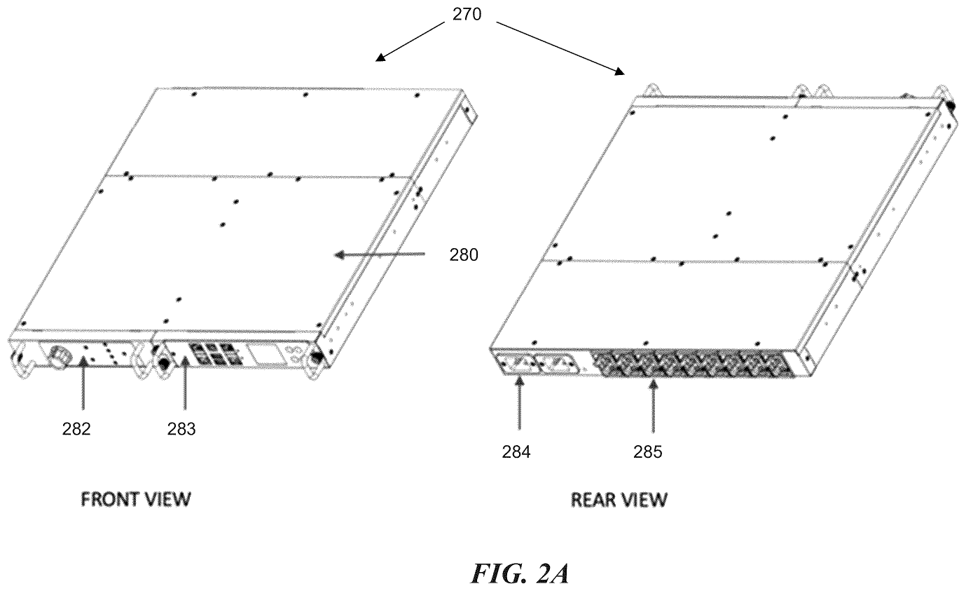

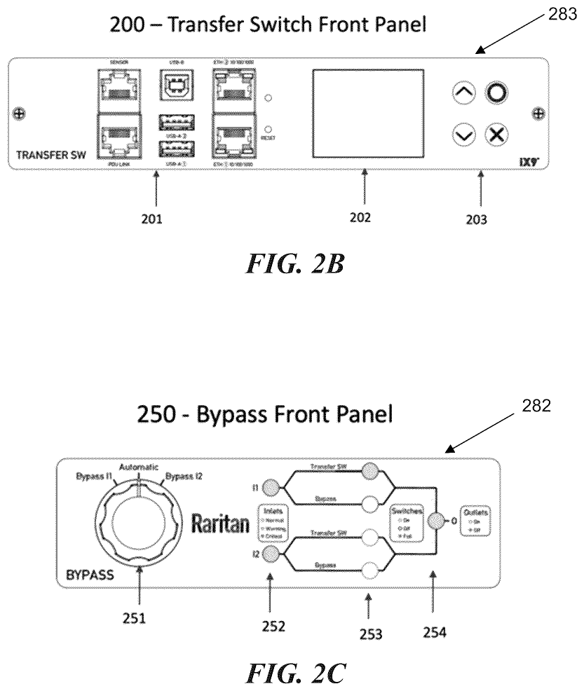

FIG. 2A illustrates front and rear perspective views of an embodiment of a rack ATS with electronic bypass. The rack ATS with electronic bypass 270 is housed in a rack mount enclosure 280, such as an industry standard 19-inch-wide rack mountable enclosure. The height of the enclosure is 1 rack unit (RU), which is equivalent to 1.75 inches. The rack mount enclosure contains two inlets 284 for connection to power sources and one or more outlets 285 for connection to electrical loads. In some implementations, the height of the enclosure is 2 RU, or 3.5 inches, depending on the number of outlets and whether circuit breakers are required for higher current electrical loads.

As illustrated in FIG. 2A, the rack ATS with electronic bypass 270 includes an electronic bypass module 282 and an ATS module 283, both of which are field replaceable modules insertable into the front of the rack mount enclosure 280.

FIG. 2B illustrates a representative front panel 200 of the ATS module 283. The front panel 200 can include multiple connectors 201. For example, the connectors 201 may include an ethernet port which enables the ATS module 283 to be remotely managed over an ethernet network.

In some embodiments, the connectors 201 may permit attachment of external sensors such as a humidity, temperature, water, and/or air pressure sensors. The connectors 201 may also permit attachment of USB devices, such as memory devices containing firmware updates for the microprocessors contained within the ATS module 283 and the electronic bypass module 282.

The front panel 200 of the ATS module 283 can also include a liquid crystal display (LCD) 202. The LCD 202 allows the operator to view the status of the power sources and the operation and configuration of the rack ATS with electronic bypass 270. In some embodiments, the front panel of the transfer switch module 283 includes a keypad 203. In other embodiments, the LCD 202 is a touchscreen which can eliminate the need for a keypad. The keypad, or touchscreen, allows the operator to navigate menu and selection options displayed on the LCD 202.

In some embodiments, a communication interface enables communication of information between the electronic bypass module 282 and the ATS module 283. This allows, in some embodiments, monitoring of status and operating conditions of both the electronic bypass module 282 and the ATS module 283 via the LCD 202, or remote monitoring via the ethernet network.

The front panel 200 of the ATS module 283 can also include a microprocessor that implements the functionality associated with one of more of the connectors 201, LCD 202, and keypad 203 and communicates with the ATS module's microprocessor 333.

FIG. 2C illustrates a representative front panel 250 of the electronic bypass module 282. The front panel 250 includes a 3-pole 1-throw low-voltage selector switch 251. In an implementation as illustrated in FIG. 2C, the selector switch 251 includes three positions that control the bypass function. When the selector switch 251 is in the Automatic position, power to the outlets is supplied by the ATS module 283, and the ATS module 283 determines which inlet supplies power to the outlets. When the selector switch 251 is placed in the Bypass I1 position, the electronic bypass module's microprocessor 313 executes an algorithm resulting in the outlets being powered through the electronic bypass module 282 by inlet 1 and disconnecting the ATS module 283 such that the ATS module 283 can be replaced. When the selector switch 251 is placed in the Bypass I2 position, a similar algorithm to bypass to inlet 2 is performed by the electronic bypass module's microprocessor 313.

The front panel 250 of the electronic bypass module 282 can include a visual display. In the embodiment illustrated in FIG. 2B, light emitting diodes (LEDs) 252, 253 and 254 are used to display the power quality of the power sources, the status of the power switching circuits, and the power being delivered to the outlet(s).

Tri-color green/yellow/red LEDs 252 display the power quality of the power sources: green (normal) indicates good power quality, yellow (warning) indicates acceptable but suboptimal power quality, and red (critical) indicates loss of power or power quality insufficient to provide power. In some embodiments, the LED indicators may only have green and red LED lights, indicating whether the associated power source is acceptable to power the electrical loads.

Two-color red/green LEDs 253 indicate the status of power switching circuitry within the ATS module 283 and electronic bypass module 282. No color (OFF) indicates the corresponding power switching circuitry is turned off and is not supplying power to the outlet(s). Green (ON) indicates the corresponding power switching circuitry is turned on and supplying power to the outlet(s). Red (FAIL) indicates the corresponding power switch circuitry is experiencing a failure, indicating that the module with the defective power switch circuitry should be replaced. For example, FIG. 2C illustrates a scenario in which (1) the selector switch 251 is in the Automatic position, and, (2) the topmost two-color red/green LED 253 is green, indicating that the ATS module 283 is supplying power to the outlets from inlet 1, and (3) the remaining two-color red/green LEDs 253 are turned off, indicating all other power switching circuits are turned off and none of the power switching circuits is experiencing a failure.

Two color red/green LEDs 254 indicate whether power is being supplied to the outlets. Green indicates power is being supplied and red indicates no power is being supplied. In some embodiments, each outlet may be associated with an individual LED to signal the status of power to each outlet.

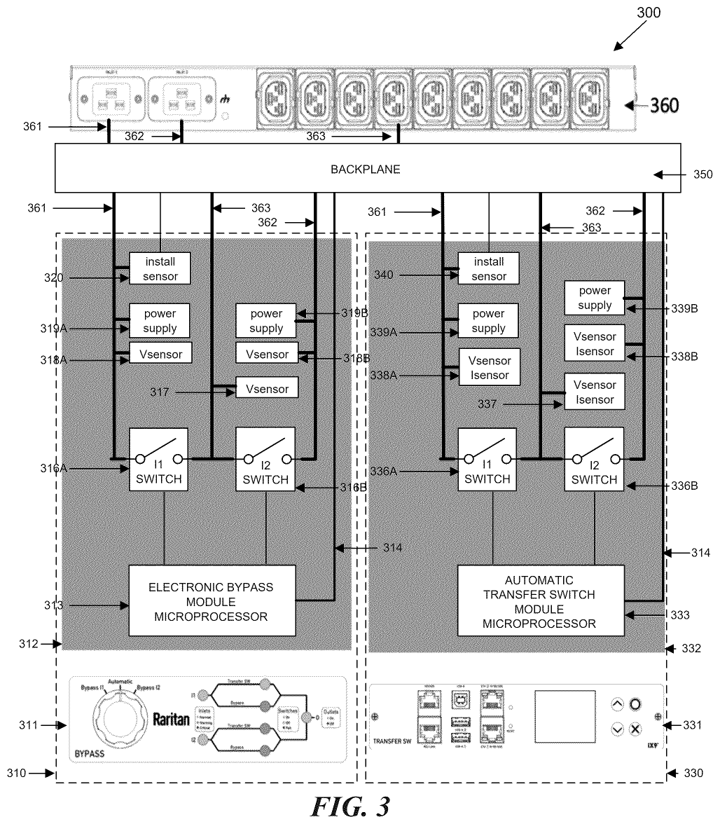

FIG. 3 is a block diagram illustrating a hardware circuitry block diagram 300 and wiring interconnection within the rack ATS with electronic bypass 270. AC power circuit wiring is depicted using one-line diagramming to represent either a two-wire single phase AC circuit or a three or more wire three-phase AC circuit. Line 361 is a one-line diagram depicting inlet 1 wiring conductors. Line 362 is a one-line diagram depicting inlet 2 wiring conductors. Line 363 is a one-line diagram depicting the outlets wiring conductors. As illustrated in FIG. 3, the enclosure's rear panel 360 includes the inlets and outlets receptacles. The number of outlets and the types of receptacles vary by model and depends on the power rating of the rack ATS as well as international electrical requirements and customer preferences. Accordingly, the rear panel 360 depicts only one of many possible configurations for representative purposes only.

The rear panel 360 receptacles interconnect with an electronic bypass module 310 and an ATS module 330 using backplane 350. As previously explained, the electronic bypass module 310 and the ATS module 330 are field replaceable modules that are removably plugged into the backplane 350. The electronic bypass module 310 is functionally equivalent to the electronic bypass module 282 of FIG. 2C, and the ATS module 330 is functionally equivalent to the ATS module 283 of FIG. 2B.

The electronic bypass module 310 includes a front panel 311, similar to the front panel as depicted in FIG. 2C. The electronic bypass module 310 includes a printed circuit board (PCB) 312 containing the electronic bypass module's circuitry. The PCB 312 can include: (1) an install sensor 320, (2) two power supplies 319A-B, each connected to a respective inlet, (3) two inlet voltage sensors 318A-B, each connected to a respective inlet, (4) an outlet voltage sensor 317 connected to the outlet(s), (5) two power switch circuits 316A-B to provide power to the outlet(s): one for inlet 1 and the other for inlet 2, (6) an electronic bypass module's microprocessor 313, and (7) a communication interface 314. Various common components are omitted from FIG. 3 for brevity. Other implementations of the electronic bypass module 310 include additional, fewer, or different components on the PCB 312.

The electronic bypass module's microprocessor 313 can control the functionality of the electronic bypass module 310. The electronic bypass module's microprocessor 313 may include (1) analog-to-digital converters to digitize analog signals from one or more voltages sensors 317 and 318A-B, (2) digital inputs to sense digital on/off signals such as the selector switch 251 and install sensor 320, (3) digital outputs to control on/off circuitry such as the two power switch circuits 316A-B and front panel LEDs 252, 253 and 254, and (4) communications circuits, such as RS-485, used as the communication interface 314 with the ATS module's microprocessor 333. To this end, and without limiting this disclosure, the electronic bypass module's microprocessor 313 may be a ST Microelectronics STM32F030C8T6.

The two power switch circuits 316A-B can control which inlet powers the outlet(s). In some implementations, the power switch circuits 316A-B are semiconductor devices in parallel with either relays or contactors. When selector switch 251 is in the automatic position, both power switch circuits 316A-B are open. When the selector switch 251 is in the Bypass I1 position, the power switch circuit 316A connected to inlet 1 is closed, allowing power flow from inlet 1 to the outlet(s). Alternatively, when the selector switch 251 is in the Bypass I2 position, the power switch circuit 316B connected to inlet 2 is closed, allowing power flow from inlet 2 to the outlet(s).

The outlet voltage sensor 317 produces an analog signal proportional to the outlet voltage. The electronic bypass module's microprocessor 313 can use the outlet voltage sensor 317 to determine whether the power switch circuits 316A-B are functioning correctly. In some implementations, the electronic bypass module's microprocessor 313 also uses the outlet voltage sensor 317 to control the front panel LED 254.

The inlet voltage sensors 318A-B produce signals proportional to the inlet voltages. The electronic bypass module's microprocessor 313 can use the inlet voltage sensors 318 to determine the power quality associated with the power source connected to each inlet. In some implementations, the electronic bypass module's microprocessor 313 can prevent bypass to a power source with poor power quality.

The low voltage power supplies 319A-B can power the PCB 312 of the electronic bypass module 310. The low voltage power supplies 319A-B ensure the PCB 312 receives power when one or the other power source fails.

The install sensor 320 can produce a signal indicating whether the electronic bypass module PCB 312 is fully inserted into the backplane 350. The install sensor can be used to prevent power delivery to the outlets until the electronic bypass module PCB 312 is fully inserted. In some implementations, the install sensor 320 is wired through the backplane 350 to the ATS module's microprocessor 333 allowing the ATS module's microprocessor 333 to determine whether the electronic bypass module 310 is installed.

The install sensor 320, in combination with the electronic bypass module's microprocessor 313, can delay activating the power switch circuits 316A-B for a certain period of time, after installation of the electronic bypass module 310, in order to prevent arcing damage to the backplane 350. In some embodiments, prior to removing the installed electronic bypass module 310, the install sensor 320 communicates to the electronic bypass module's microprocessor 313 that the electronic bypass module 310 is being removed. Upon receiving the information regarding module removal, the electronic bypass module's microprocessor 313 can force the opening of the power switch circuits 316A or 316B to prevent electrical arcing damage to the backplane 350. Additionally, upon receiving the information regarding module removal, the electronic bypass module's microprocessor 313, via the communication interface 314, can communicate the information to the ATS module's microprocessor 333.

The ATS module 330 includes a front panel 331, similar to the front panel depicted in FIG. 2B, and a printed circuit board (PCB) 332 containing the ATS module's circuitry. The PCB 332 can include: (1) an install sensor 340, (2) two low-voltage power supplies 339A-B, each connected to a respective inlet, (3) two sets of inlet voltage and current sensors 338A-B, each set connected to a respective inlet, (4) outlet voltage and current sensors 337 connected to the outlet(s), (5) an ATS module's microprocessor 333, and (6) a communication interface 314. Various common components are omitted from FIG. 3 for brevity. Other implementations of the transfer switch module 330 include additional, fewer, or different components in the PCB 332.

The ATS module's microprocessor 333 controls the functionality of the ATS module 330. The ATS module's microprocessor 333 may include (1) analog-to-digital convertors to digitize analog signals from one or more of the voltage and current sensors 337 and 338A-B, (2) digital inputs for sensors such as the install sensor 340, (3) digital outputs to control on/off circuitry such as the two power switch circuits 336A-B, and (4) communications circuits, such as RS-485, used for the communication interface 314 with the electronic bypass module's microprocessor 313 and the ATS front panel's microprocessor. To this end, and without limiting this disclosure, the ATS module's microprocessor 333 may be ST Microelectronics Part No. STM32F446ZCJ6 (or alternatively, STM32F446ZCJ7, STM32F446ZEJ6 or STM32F446ZEJ7) or Giga Device Part No. GD32F427IKH6.

The two power switch circuits 336A-B can control which inlet powers the outlets. In some implementations, the power switch circuits 336A-B are semiconductor devices in parallel with either relays or contactors. When the selector switch 251 is in the Automatic position, the ATS module's microprocessor 333 determines which inlet powers the outlets by closing one of the two power switch circuits 336A-B.

The outlet voltage and current sensors 337 produce analog signals proportional to the outlet voltage and current. The outlet voltage and current sensors 337 can be used to verify that the power switch circuits 336A-B are functioning correctly.

The inlet voltage and current sensors 338A-B produce analog signals proportional to the voltage and current flowing in each inlet. The ATS module's microprocessor 333 can use the inlet voltage and current sensors 338A-B to determine each power source's power quality. When the selector switch 251 is in the Automatic position, the ATS module's microprocessor 333 can use the power quality measurements to select which inlet powers the outlet(s). In some embodiments the current sensors can be used to detect failures in the power switches 336. In some embodiments, the inlet voltage and current sensors 338A-B are used by the ATS module's microprocessor 333 to produce power meter measurements such as voltage, current, power, energy, and power factor.

The low voltage power supplies 339A-B power the PCB 332. The low voltage power supplies 339A-B ensure the PCB 332 receives power when one or the other power sources fails.

The install sensor 340 can produce a signal indicating whether the ATS module PCB 332 is fully inserted into the backplane 350. The install sensor can be used to prevent power delivery to the outlets until the ATS module PCB 332 is fully inserted. In some implementations, the install sensor 340 is wired through the backplane 350 to the electronic bypass module's microprocessor 313 allowing the electronic bypass module's microprocessor 313 to determine whether the ATS module 330 is installed.

The install sensor 340, in combination with the ATS module's microprocessor 333, can delay activating the power switch circuits 336A-B for a certain period of time, after installation of the ATS module 330, in order to prevent arcing damage to the backplane 350. In some embodiments, prior to removing the installed ATS module 330, the install sensor 340 communicates to the ATS module's microprocessor 333 that the ATS module 330 is being removed. Upon receiving the information regarding module removal, the ATS module's microprocessor 333 can force the opening of the power switch circuits 336A or 336B to prevent electrical arcing damage to the backplane 350. Additionally, upon receiving the information regarding module removal, the ATS module's microprocessor 333 can communicate the information to the electronic bypass module's microprocessor 313.

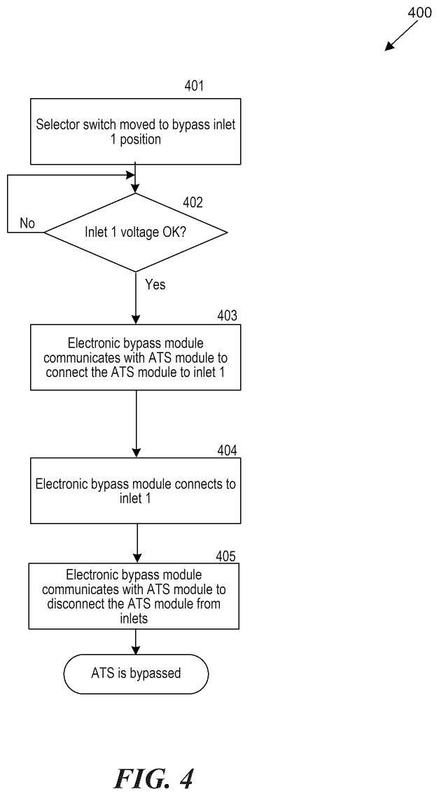

FIG. 4 is a flowchart illustrating a representative algorithm 400 of the sequence of steps which may be used by the electronic bypass module's microprocessor 313 to bypass the ATS module 330 so that it may be removed and replaced.

In step 401, the selector switch 251 on the front panel 250 of the electronic bypass module 282 is moved from Automatic to the Bypass I1 position, which initiates the bypass operation.

In step 402, the bypass operation is prevented unless and until inlet 1 voltage is present and within an acceptable range, as sensed by the inlet voltage sensor 318A corresponding to inlet 1. In some implementations, the inlet voltage sensor 318A continues to monitor the inlet 1 voltage until the inlet 1 voltage is present and within the acceptable range. Step 402 prevents loss of power to the outlet(s) if the operator makes an error by moving the selector switch 251 to the Bypass I1 position when power is not available on inlet 1.

In step 403, the electronic bypass module's microprocessor 313 communicates with the ATS module's microprocessor 333 using the communication interface 314. The ATS module's microprocessor 333 is instructed to take the ATS module 330 out of Automatic operation and power the outlet(s) through the ATS module's power switch circuit 336A connected to inlet 1. This step ensures inlet 1 and inlet 2 are not connected to the outlet(s) at the same time, which could result in a short circuit, during the remaining steps of the bypass operation.

In step 404, the outlet(s) are powered by inlet 1 through the electronic bypass module's power switch circuit 316A connected to inlet 1. The outlet(s) are now powered by inlet 1 through both the ATS and bypass modules.

In step 405, the electronic bypass module's microprocessor 313 communicates with the ATS module's microprocessor 333 using the communication interface 314. The ATS module's microprocessor 333 is instructed to turn off the power switch circuit 336A connected to inlet 1, resulting in the electronic bypass module 310 powering the outlet(s) from inlet 1. At this point, the ATS module 330 no longer powers the outlet(s) and can be removed and replaced.

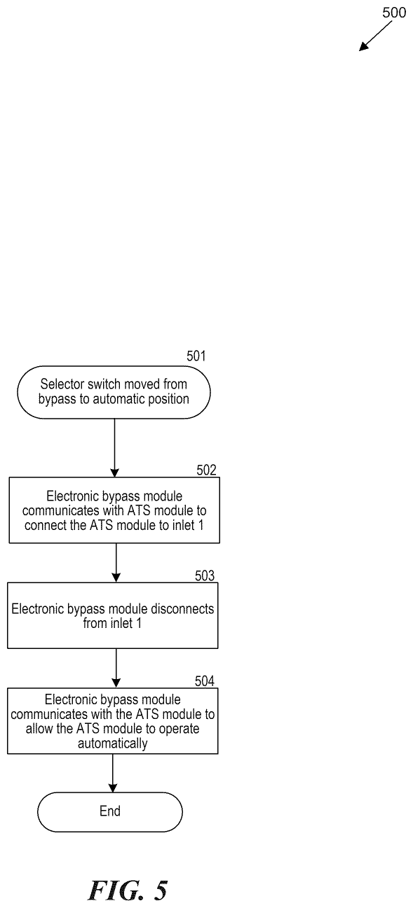

FIG. 5 is a flowchart illustrating a representative algorithm 500 of the sequence of steps which may be used by the electronic bypass module's microprocessor 313 after the ATS module 330 has been replaced such that the electronic bypass module 310 is electrically disconnected from an inlet.

In step 501, the selector switch 251 is moved from the Bypass I1 position to the Automatic position.

In step 502, the electronic bypass module's microprocessor 313 communicates with the ATS module's microprocessor 333 using the communication interface 314. The ATS module 330 is instructed to power the outlet(s) through the ATS module's power switch circuit 336A connected to inlet 1 such that the outlet(s) are powered by inlet 1 through both the ATS module 330 and the electronic bypass module 310.

In step 503, the electronic bypass module's power switch circuit 316A connected to inlet 1 is turned off, resulting in the outlet(s) being powered only by the ATS module 330.

In step 504, the electronic bypass module's microprocessor 313 communicates with the ATS module's microprocessor 333 using the communication interface 314. The ATS module 330 is instructed to resume automatic operation allowing the ATS module 330 to choose which inlet to power the outlet(s) as determined by inlet 1 and inlet 2 power quality.

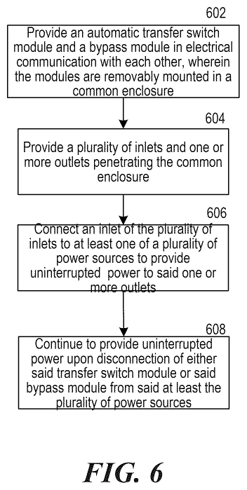

FIG. 6 is a flowchart illustrating a representative process for provisioning power from one of the power inlets to the power outlets, according to some implementations. In step 602, an automatic transfer switch module and a bypass module in electrical communication with the automatic transfer switch module are provided. Each module is removably mounted in a common enclosure.

In step 604, a plurality of inlets and one or more outlets penetrating the common enclosure are provided. Each of the plurality of inlets is connectable to a power source of a plurality of power sources. The one or more outlets are connectable to an electrical load.

In step 606, an inlet of the plurality of inlets is connected to at least one of a plurality of power sources to provide uninterrupted power to the one or more outlets.

In step 608, upon disconnection of the automatic transfer switch module, the bypass module continues to provide uninterrupted power to the one or more outlets. Disconnection of the automatic transfer switch module is allowed only upon determining that power is being provisioned through the bypass module. Alternatively, disconnection of the bypass module is allowed only upon determining that power is being provisioned through the automatic transfer switch module. Upon disconnection of the bypass module, the automatic transfer switch module provides uninterrupted power to the one or more outlets.

### Remarks

The terms “automatic transfer switch” and “ATS” are used interchangeably.

The terms “mean time to replacement” and “MTTR” are used interchangeably.

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A switching device, comprising:
an enclosure mountable in an electronic equipment rack;
an automatic transfer switch module removably disposed in said enclosure;
a bypass module removably disposed in said enclosure;
a pair of inlets penetrating said enclosure, each of said inlets connectable to a first power source and a second power source, respectively;
at least one outlet penetrating said enclosure and connectable to an electrical load; and
switching circuitry that includes a plurality of switch positions, said switching circuitry interconnecting said automatic transfer switch module and said bypass module, said switching circuitry including an inlet voltage sensor and operative, irrespective of said switch positions, to prevent loss of power to said at least one outlet until a bypass module inlet voltage is present and within an acceptable range.

2. (canceled)

3. The switching device of claim 1 wherein said switching circuitry includes an automatic transfer switch microprocessor and a bypass microprocessor in electrical communication with said transfer switch microprocessor.

4. The switching device of claim 3 wherein said automatic transfer switch microprocessor and said bypass microprocessor are operative to cooperate with one another to ensure provisioning of power from one of the first power source or the second power source to said at least one outlet upon removal of said automatic transfer switch module.

5. The switching device of claim 3 wherein said bypass microprocessor is operative to monitor a status of said automatic transfer switch module.

6. The switching device of claim 3 wherein said bypass microprocessor is operative to monitor availability of input power, supply of output power to the at least one outlet, if any, and status of said automatic transfer switch module.

7. The switching device of claim 3 wherein said bypass microprocessor is operative to override and disconnect said automatic transfer switch module, thereby preventing said automatic transfer switch module from determining the power source from which power is provisioned.

8. The switching device of claim 1 wherein said bypass module is an electronic bypass module.

9. The switching device of claim 8 wherein said electronic bypass module includes a low voltage, low power three-position switch, comprising:
a first position for provisioning power from the first power source through said electronic bypass module;
a second position for provisioning power from the second power source through said electronic bypass module; and
a third position for enabling said automatic transfer switch module to determine an associated power source from which power is provisioned.

10. The switching device of claim 8, wherein said electronic bypass module includes one or more power relays, from which power is provisioned, that are activated by a low power signal.

11. The switching device of claim 1 wherein said enclosure is sized to fit with a 1U rack space.

12. The switching device of claim 1 wherein said enclosure is a dual compartment enclosure having a first compartment in which said automatic transfer switch module is removably disposed and a second compartment in which said bypass module is removable disposed.

13. A switching device, comprising:
a pair of inlets each connectable to a first power source and a second power source, respectively;
one or more outlets for provisioning power from a selected one of said first power source and said second power source to one or more connected electric devices, if any;
an automatic transfer switch module connectable to said first power source, said second power source and said one or more outlets;
a bypass module connectable to said first power source, said second power source and said one or more outlets; and
switching circuitry that includes a plurality of switch positions, said switching circuitry interconnecting said automatic transfer switch module and said bypass module, said switching circuitry including an inlet voltage sensor and operative, irrespective of said switch positions, to prevent loss of power to said one or more outlets until a bypass module inlet voltage is present and within an acceptable range.

14. A rack-mountable switching device, comprising:
a dual compartment enclosure, comprising:
a first compartment configured to removably accommodate an automatic transfer switch module;
a second compartment configured to removably accommodate a bypass module;
a field-replaceable automatic transfer switch module removably disposed in said first compartment; and
switching circuitry that includes a plurality of switch positions, said switching circuitry interconnecting said field-replaceable automatic transfer switch module and said bypass module, said switching circuitry including an inlet voltage sensor and operative, irrespective of said switch positions, to prevent loss of power to said switching device until a bypass module inlet voltage is present and within an acceptable range.

15. The rack-mountable switching device of claim 14 further comprising a bypass module removably disposed in said second compartment.

16. The rack-mountable switching device of claim 15 wherein said bypass module is an electronic bypass module.

17. The rack-mountable switching device of claim 14 wherein said dual compartment enclosure is sized to fit within a 1U rack space.

18. A power provisioning method using a common enclosure mountable in an electronic equipment rack, comprising:
providing an automatic transfer switch module removably mounted in said common enclosure;
providing a bypass module in electrical communication with said automatic transfer switch module via switching circuitry having a plurality of switch positions and an inlet voltage sensor, wherein said bypass module is removably mounted in said common enclosure;
providing a plurality of inlets penetrating said common enclosure, each of said inlets connectable to a power source of a plurality of power sources;
providing one or more outlets penetrating said common enclosure and connectable to an electrical load;
connecting an inlet of the plurality of inlets to at least one of a plurality of power sources to provide uninterrupted power to said one or more outlets; and
continuing to provide uninterrupted power to said one or more outlets upon disconnection of either said transfer switch module or said bypass module from said at least one of the plurality of power sources, irrespective of said switch positions, and until a bypass module inlet voltage is present and within an acceptable range.

19. The power provisioning method of claim 18, wherein continuing to provide uninterrupted power upon disconnection of said automatic transfer switch module from said at least one of the plurality of power sources further comprises:
determining whether power is being provisioned from at least one power source through said bypass module or said automatic transfer switch module, and
allowing disconnection of said transfer switch module only upon determining that power is being provisioned through said bypass module.

20. The power provisioning method of claim 19 further comprising placing said bypass module in a first state to disconnect said automatic transfer switch module and provision power from one of the plurality of power sources through the bypass module.

21. The power provisioning method of claim 20 further comprising placing said bypass module in a second state to enable said automatic transfer switch module to determine the power source from which power is provisioned.
